(19) United States
(12) Patent Application Publication
(10) Pub. No.: US 2014/0344631 A1
(43) Pub. Date: Nov. 20, 2014

(54) ELECTRONIC DEVICE AND METHOD FOR RELEASING ELECTRONIC DEVICE FROM NONFUNCTIONING STATE

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventors: XIAO-WEI YANG, Shenzhen (CN); JUN-JUAN GAO, Shenzhen (CN); YANG WANG, Shenzhen (CN); CHUN-CHING CHEN, New Taipei (TW)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 14/093,360

(22) Filed: Nov. 29, 2013

(30) Foreign Application Priority Data
May 20, 2013 (CN) 2013101880837

(51) Int. Cl. G06F 11/07

(52) U.S. Cl. CPC G06F 11/0721
USPC 714/49

(57) ABSTRACT

An electronic device includes a CPU and an MCU intercommunicating with the CPU. The MCU sends an instruction to the CPU at a predetermined time interval. The MCU detects whether a response is received from the CPU within a predetermined time period after the instruction is sent, and determines that the CPU is nonfunctioning when no response is received from the CPU. The MCU restarts the CPU when the CPU is determined to be nonfunctioning. A method for releasing an electronic device from a nonfunctioning state is also provided.

### BACKGROUND

1. Technical Field

The present disclosure relates to electronic devices and a method for releasing an electronic device from a nonfunctioning state.

2. Description of Related Art

An electronic device, such as a digital video disk (DVD) player, may be nonfunctioning (namely, it powers on but don't play) because of abnormalities or misoperations of a user. When the electronic device is nonfunctioning, the electronic device may not respond to inputted commands from a user, and the electronic device may be released from the nonfunctioning state by rebooting or resetting the electronic device. However, this is an inconvenience because a user may lose unsaved data and it is time consuming.

Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of an electronic device in accordance with an embodiment.

FIG. 2 is a flowchart of a method for releasing an electronic device from a nonfunctioning state in accordance with an embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

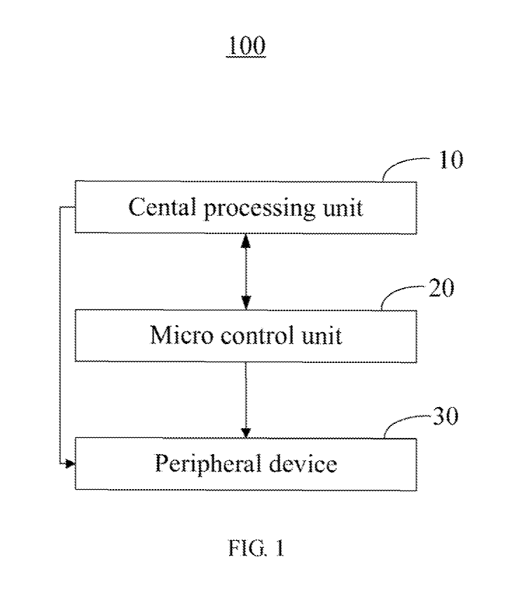

FIG. 1 shows an electronic device 100 in accordance with an embodiment. The electronic device 100 can be released from a nonfunctioning state resulting from abnormalities or misoperations without any user involvement. The electronic device 100 can be a mobile phone or a portable digital video disk (DVD) player, for example. In the embodiment, the electronic device 100 is a portable DVD player. The electronic device 100 includes a central processing unit (CPU) 10, a micro control unit (MCU) 20, and various peripheral devices 30, such as a loudspeaker, display, power supply, and the like.

In a normal working state, the CPU 10 carries out instructions of a program of the electronic device 100. In a nonfunctioning state, the CPU 10 cannot respond to any instructions from other programs and/or components, and the program executed by the CPU 10 is nonfunctioning. For example, when the CPU 10 outputs audio signals, the procedure of outputting audio signals will be nonfunctioning if the CPU 10 enters the nonfunctioning state, and any audio generated or outputted may be garbled.

The MCU 20 intercommunicates with the CPU 10. When the CPU 10 is in the nonfunctioning state, the MCU 20 is kept in a normal working state. The MCU 20 interacts with and controls the peripheral devices 30. For example, the MCU 20 carries out a detection of the power supply, turns on/off the electronic device 100 in response to a signal from a power switch, awakes the display from a sleeping state, and the like. In the embodiment, when the electronic device 100 is powered on, the MCU 20 continuously detects whether the CPU 10 is in the nonfunctioning state and restarts the CPU 10 when the CPU 10 is determined to be in the nonfunctioning state. As a result, the electronic device 100 can be released from the nonfunctioning state without any user involvement. In detail, the MCU 20 sends an instruction to the CPU 20 at a predetermined time interval, such as 0.0001 second (s), and the CPU 20 responds to the instruction and returns a response to the MCU 20 when in the normal working state. When the CPU 10 is in a nonfunctioning state, the CPU 10 cannot return a response to the MCU 20, and the MCU 20 cannot receive a response from the CPU 10. The MCU 20 detects whether a response is received from the CPU 10 within a predetermined time period after the instruction is sent. If a response is received from the CPU 10 within the predetermined time period after the instruction is sent, the MCU 20 determines that the CPU 10 is in the normal working state, and the MCU 20 resends the instruction to the CPU 10 at the predetermined time interval. When no response is received from the CPU 10 within the predetermined time period after the instruction is sent, the MCU 20 determines that the CPU 10 is in the nonfunctioning state. The predetermined time period in the embodiment is less than the predetermined time interval. When the CPU 10 is nonfunctioning during the procedure of outputting audio signal, the MCU 20 mutes the audio signals to prevent the user from hearing the audio signals deadlocking The MCU 20 further times a time duration of the CPU 10 being in the nonfunctioning state and restarts the CPU 10 to release the electronic device 100 from the nonfunctioning state when the time reaches a predetermined time duration, such as 1 s.

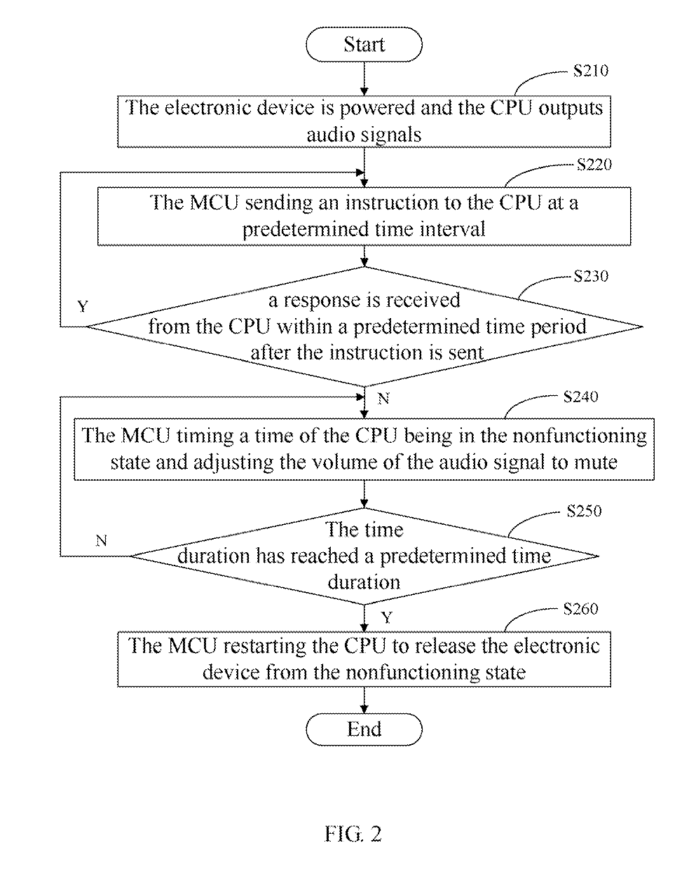

FIG. 2 is a flowchart illustrating one embodiment of a method applied to an electronic device 100 for releasing the electronic device 100 from a nonfunctioning state. The electronic device 100 includes a CPU 10 and an MCU 20 intercommunicating with the CPU 10. The CPU 10 is capable of responding to an instruction sent from the MCU 20 and returns a response to the MCU 20. The method includes the following steps:

In step S210, the electronic device 100 is powered on, and the CPU 10 outputs audio signals.

In step S220, the MCU 20 sends the instruction to the CPU 10 at a predetermined time interval.

In step S230, the MCU 20 detects whether a response is received from the CPU 10 within a predetermined time period after the instruction is sent. In the embodiment, the predetermined time period is less than the predetermined time interval. When no response is received from the CPU 10 within the predetermined time period, the MCU 20 determines that the CPU 10 is in the nonfunctioning state, and the procedure goes to step S240. Otherwise, the procedure returns to step S220.

In step S240, the MCU 20 times a time duration of the CPU 10 being in the nonfunctioning state and mutes the audio signals.

In step S250, the MCU 20 determines whether the time duration has reached a predetermined time duration. When the time reaches the predetermined time duration, the procedure goes to step S260. Otherwise, the procedure goes to step S240.

In step S260, the MCU 20 restarts the CPU 10 to release the electronic device 100 from the nonfunctioning state. As a result, the electronic device 100 is released from the nonfunctioning state without any user involvement.

Although information as to, and advantages of, the present embodiments have been set forth in the foregoing description, together with details of the structures and functions of the present embodiments, the disclosure is illustrative only; and changes may be made in detail, especially in the matters of shape, size, and arrangement of parts within the principles of the present embodiments to the full extent indicated by the broad general meaning of the terms in which the appended claims are expressed.

What is claimed is:

1. An electronic device, comprising:
a central processing unit; and
a micro control unit intercommunicating with the central processing unit and continuously sending an instruction to the central processing unit;
wherein the central processing unit does not respond to the instruction when nonfunctioning; the central processing unit responds to the instruction from the micro control unit and returns a response to the micro control unit when in a normal working state; the micro control unit detects whether a response is received from the central processing unit with in a predetermined time period after the instruction is sent, and determines that the central processing unit is nonfunctioning when no response is received from the central processing unit, and further restarts the central processing unit when the central processing unit is determined to be nonfunctioning.

2. The electronic device of claim 1, wherein the micro control unit sends the instruction to the central processing unit at a predetermined time interval.

3. The electronic device of claim 2, wherein the micro control unit further times a time duration of the central processing unit being in the nonfunctioning state when the central processing unit is determined to be in the nonfunctioning state, and restarts the central processing unit to release the electronic device from the nonfunctioning state when the time duration has reached a predetermined time duration.

4. The electronic device of claim 2, wherein the predetermined time period is less than the predetermined time interval.

5. The electronic device of claim 1, wherein the micro control unit determines that the central processing unit is in a normal working state when a response is received from the central processing unit with in a predetermined time period after the instruction is sent.

6. The electronic device of claim 1, wherein when the central processing unit is nonfunctioning during the procedure of outputting audio signals, the micro control unit mutes the audio signals when the central processing unit is determined to be nonfunctioning.

7. A method for releasing an electronic device from deadlock, the electronic device comprising a central processing unit, and a micro control unit intercommunicating with and sending an instruction to the central processing unit, the central processing unit returning a response to the micro control unit in response to the instruction when in a normal working state, and not returning the response to the micro control unit when nonfunctioning, the micro control unit performing the following steps:
sending the instruction to the central processing unit at a predetermined time interval;
detecting whether a response is received from the central processing unit within a predetermined time period after the instruction is sent;
determining that the central processing unit is nonfunctioning when no response is received from the central processing unit; and
restarting the central processing unit to release the electronic device from deadlock when the central processing unit is determined to be nonfunctioning.

8. The method of claim 7, wherein the micro control unit sends the instruction to the central processing unit at a predetermined time interval.

9. The method of claim 8, wherein the predetermined time period is less than the predetermined time interval.

10. The method of claim 8, wherein the micro control unit further performs the following steps:
timing a time duration of the central processing unit being in the nonfunctioning state when the central processing unit is determined to be nonfunctioning;
determining whether the time duration reaches a predetermined time duration; and
restarting the centre processing to release the electronic device from the nonfunctioning state when the time duration has reached a predetermined time duration.

11. The method of claim 10, further comprising:
determining that the central processing unit is in a normal working state when a response is received from the central processing unit with in the predetermined time period after the instruction is sent.

12. The method of claim 7, wherein the central processing unit outputs audio signals;
the micro control unit further performs the following steps:
muting the audio signals when the central processing unit is determined to be nonfunctioning.
